(19) United States
(12) Patent Application Publication
(10) Pub. No.: US 2021/0169092 A1
(43) Pub. Date: Jun. 10, 2021

(54) HANDHELD TOOL FOR REMOVING CHICKEN TENDON

(71) Applicant: Preston A. Gray, American Fork, UT (US)

(72) Inventor: Preston A. Gray, American Fork, UT (US)

(21) Appl. No.: 16/706,492

(22) Filed: Dec. 6, 2019

(51) Int. Cl. A22C 21/06

(52) U.S. Cl. CPC A22C 21/066; A22C 21/063

(57) ABSTRACT

A handheld tool for the removal of a tendon from a chicken tenderloin. The handheld tool comprises a handle and an integrated shaft that connects to the handle on one end and tapers from the handle to a stripping cylinder on the other end. The stripping cylinder is useful for stripping a tendon from the chicken tenderloin by a user. The free end of the chicken tendon is inserted through the fore end of the stripping cylinder. Once the tendon is passed through, the user's free hand is used to grasp the tendon. Once a secure grip is established, the tool is advanced away from the user while simultaneously pulling the tendon toward the user with the other hand as the tool strips the tendon free. The user of the tool is able to strip the tendon from the tenderloin quickly and efficiently by using this handheld tool.

### BACKGROUND

Removing the tendon from a chicken tenderloin has been both a difficult and tough problem for butchers and cooks alike. This is a problem that individuals are facing today in both home kitchens and professional kitchens. Each tenderloin, which is part of the chicken breast, has a single large tendon that courses along the length of the tenderloin. Because the tendon is where all of the individual muscle fibers attach, it is difficult to remove the tendon from the tenderloin.

Presently, the solution for butchers and cooks alike is to either leave the tendon inside of the tenderloin, or manually cutting or trimming the tendon from the breast fillet using a knife and butchering the tenderloin completely. Leaving the tendon inside of the tenderloin results in an unpleasant experience for people eating the tenderloin as they need to cut and/or chew on pieces containing the unsavory large tendon. Trimming the tendon using a knife necessitates cutting a large piece of chicken meat almost completely in half in order to access the tendon. This results in less favorable cooking conditions as the tenderloin is less likely to retain juices due to the large incision required to remove the tendon. Some butchers and cooks have also employed a method of pulling on the tendon with pliers, but even pulling the tendon with pliers can be difficult as it is laborious and the tendon may sometimes become only partially removed due to the tendon rupturing inside of the tenderloin as it is being pulled.

There have been attempts to automate the removal of the tendon from tenderloins using complex and expensive machinery, but these machines are often found in food processing plants and not in households for consumer to use.

Therefore, there exists today an unfulfilled need for an efficient and economical tendon removal tool for consumers of chicken tenderloins to have at their disposal.

### SUMMARY

A handheld tool for removing the large tendon which extends through a tenderloin or breast fillet of poultry was designed to allow for a user to remove the tendon from a chicken tenderloin with ease and precision. In this embodiment, a single instrument is disclosed comprising of a handle, an integrated shaft and a stripping cylinder end. The tool strips the flesh from the tendon, freeing it completely when it is employed by a user. The tool is designed to be used with a single hand of a user. The tool is grasped in either the left or right hand of the user, and with the thumb groove at the upward portion of the handle. The free end of the tendon is inserted through the fore end of the stripping cylinder. Once the tendon is passed through, the user's free hand is used to grasp the tendon. Once a secure grip is established, the tool is advanced away from the user while simultaneously pulling the tendon toward the user with the other hand as the tool strips the tendon free. The user of the tool is able to remove the tendon quickly and efficiently by using this tool.

The handheld tool for removing chicken tendons is safe for use by amateur cooks and experienced sous-chefs alike. The tool is lightweight, so it is unlikely to be dropped by users. Additionally, because pressure is applied with the tool, the stripping cylinder end does not require a sharp cutting edge and does not require a chamfered edge. This tool does not have the same inherent danger as a knife as it does not have a long sharp edge, but only a stripping cylinder end that is used by advancing the tool away from the user.

### BRIEF DESCRIPTION OF THE DRAWINGS

A further understanding of the nature and advantages of the embodiments may be realized by reference to the following drawings. In the appended figures, similar components or features may have the same reference label.

FIG. 1 depicts an overall frontal perspective view of the presently preferred embodiment of the handheld tool.

FIG. 2 depicts a perspective view of the bottom of the tool.

FIG. 3 is a cross-sectional view lengthwise of the tool.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF THE PREFERRED EMBODIMENT

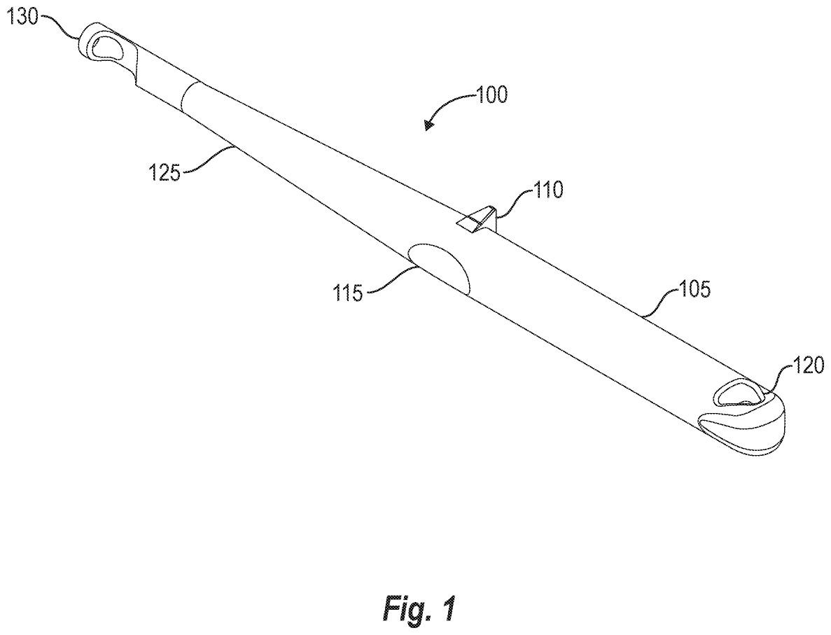

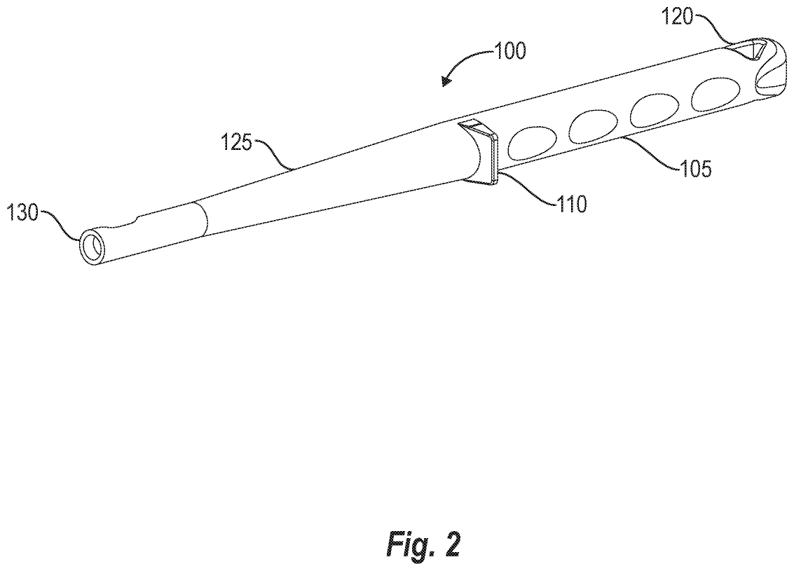

Referring to FIGS. 1 and 2, the present invention is a handheld tool 100 for the removal of the large tendon which extends through a tenderloin or breast fillet of poultry. The handheld tool 100 includes, in combination, a straight handle 105, with an integrated shaft 125, connected to the stripping cylinder 130. The stripping cylinder 130 allows for the large tenderloin to pass through the cylindrical opening. The straight handle 105 defining a longitudinal axis of the handheld tool 100. The stripping cylinder 130 is perpendicular to the longitudinal axis of the straight handle 105.

The straight handle 105, has a thumb grip 115, and a stand support 110. The straight handle 105, the integrated shaft 125 are preferably rounded in shape to allow users ease of grip. The stand support 110 feature allows the handheld tool 100 to be placed on a flat surface without the tool rolling or moving. The thumb grip 115 allows for a more secure grip. The straight handle 105, preferably has additional grips for other fingers to securely grip the handheld tool 100 that are demonstrated in FIG. 2. The handle has a hanging slot 120 for hanging storage of the handheld tool 100.

The integrated shaft 125 tapers from the straight handle 105 to the stripping cylinder 130 are preferably made of one of the rigid plastics that are well known in the art. Most preferably, the handheld tool 100 is of one-piece construction. This type of construction allows the handheld tool 100 to be made inexpensively. Additionally, this one piece construction allows for the handheld tool 100 to be cleaned easier than with multi-piece construction as there is no disassembly or assembly required during cleaning. Although different overall lengths may be used, the preferred length is approximately 9.25 inches.

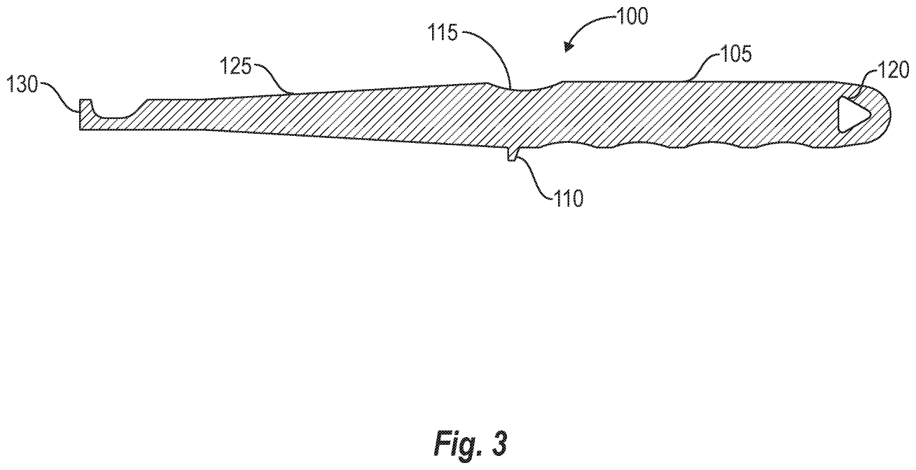

FIG. 3 presents a cross-sectional view lengthwise of the handheld tool 100. The cross-sectional view further demonstrates the one-piece construction of the integrated shaft 125, the straight handle 105, the stripping cylinder 130, the stand support 110, the thumb grip 115, and the hanging slot 120. The cross-sectional view demonstrates that the stripping cylinder 130 is perpendicular to the longitudinal axis of the straight handle 105.

The stripping cylinder 130 is suited for stripping the tendon free from the tenderloin of a chicken. Once a secure grip is established on the straight handle 105, using the thumb grip 115, the handheld tool 100, is advanced away from the user while the user simultaneously pulls the tendon toward the user with the other hand as the tool strips the tendon free.

It is to be understood that the present invention is not limited to the sole embodiment described above, but encompasses any and all embodiments within the scope of the following claims.

What is claimed is:

1: A handheld tool for removing a tendon from a chicken tenderloin comprising, in combination;
a straight handle defining a longitudinal axis, with said straight handle having a thumb grip, a stand support, and a hanging slot;
an integrated shaft that is connected to the straight handle and tapers from the straight handle to a stripping cylinder; and
said stripping cylinder being perpendicular to the straight handle and the integrated shaft.

2: The handheld tool according to claim 1, wherein said handheld tool is of one-piece construction.

3: The handheld tool according to claim 1, wherein said handheld tool is made of plastic.

4: The handheld tool according to claim 1, wherein said handheld tool has an overall length from the stripping cylinder to the hanging slot, said overall length being approximately 9.25 inches.

5. A handheld tool for removing a tendon from a chicken tenderloin comprising, in combination;
a straight handle;
an integrated shaft that is connected to the straight handle and tapers from the straight handle to a stripping cylinder; and
said stripping cylinder being perpendicular to the straight handle and the integrated shaft.

6. The handheld tool according to claim 5, wherein said handheld tool has a thumb grip.
